(19) United States
(12) Patent Application Publication
(10) Pub. No.: US 2017/0309938 A1
(43) Pub. Date: Oct. 26, 2017

(54) FUEL CELL SYSTEM

(71) Applicant: TOYOTA JIDOSHA KABUSHIKI KAISHA, Toyota-shi, Aichi-ken (JP)

(72) Inventor: Shigeaki MURATA, Nisshin-shi, Aichi-ken (JP)

(73) Assignee: TOYOTA JIDOSHA KABUSHIKI KAISHA, Toyota-shi, Aichi-ken (JP)

(21) Appl. No.: 15/517,278

(22) PCT Filed: Oct. 8, 2015
(86) PCT No.: PCT/JP2015/078579

§ 371 Date: Apr. 6, 2017

(30) Foreign Application Priority Data
Oct. 9, 2014 (JP) 2014-208419
Oct. 7, 2015 (JP) 2015-199144

(51) Int. Cl. H01M 8/04746; H01M 8/04089; H01M 8/04992; H01M 8/04082; H01M 8/1018

(52) U.S. Cl. CPC H01M 8/04761; H01M 8/04992; H01M 8/04201; H01M 8/04097; H01M 2008/1095; H01M 2250/20

(57) ABSTRACT

A fuel cell system includes: a fuel cell stack including a cathode passage and an anode passage formed thereinside; and a cathode gas supply passage including a first pump discharging cathode gas and connected to an inlet of the cathode passage. The fuel cell system further includes: a cathode off-gas exhaust passage including a back pressure valve and connected to an outlet of the cathode passage; and a circulation passage including a second pump discharging cathode off-gas to circulate cathode off-gas. The fuel cell system circulates cathode off-gas during idling operation to decrease cathodic potential, and increases an opening degree of the back pressure valve to greater than that during idling operation to decrease the cathode back pressure to less than that during idling operation after idling operation is shifted to load operation. This configuration promptly replaces gas in the fuel cell stack.

### TECHNICAL FIELD

The present invention relates to a fuel cell system.

### BACKGROUND ART

To prevent a cathode electrode from having high electric potential while a fuel cell system is on standby for power generation, there has been known an art that circulates cathode gas during standby for power generation to reduce the voltage (for example, see Patent Document 1). When the cathode electrode is prevented from having high electric potential during standby for power generation, the deterioration of the fuel cell is inhibited. Patent Document 2 is another document relating to such a technology.

### PRIOR ART DOCUMENT

### Patent Document

[Patent Docuemnt 1] Japanese Patent Application Publication No. 2009-252552

[Patent Document 2] Japanese Patent Application Publication No. 2003-115317

### SUMMARY OF THE INVENTION

### Problems to be Solved by the Invention

As disclosed in Patent Document 1 and Patent Document 2, in the fuel cell system that executes the circulation control of cathode gas in a power generation standby state, the circulation control decreases the oxygen concentration in the cathode gas inside the stack. Thus, even when the circulation control of cathode gas is stopped to increase the air supply amount by an air supply compressor when the power generation standby state is switched to a power generation request state, it takes time for oxygen to be supplied across the entire area of the stack to allow the high-output power generation to be possible. When the supply of oxygen delays, the efficiency of the fuel cell system decreases. The reason why the supply of oxygen delays is because it takes time to replace the gas in the fuel cell stack that has been filled with cathode gas with a low oxygen concentration.

Accordingly, the fuel cell system disclosed in the present description aims to promptly replace gas in a fuel cell stack after the circulation control of cathode gas.

### Means for Solving the Problems

To solve the above problem, a fuel cell system disclosed in the present description includes: a fuel cell stack that is formed by stacking unit cells each including a cathode electrode, an anode electrode, and an electrolyte membrane arranged between the cathode electrode and the anode electrode, and includes a cathode passage and an anode passage formed inside the fuel cell stack; a cathode gas supply passage that includes a first pump that discharges cathode gas and is arranged in the cathode gas supply passage, and is connected to an inlet of the cathode passage; a cathode off-gas exhaust passage that includes a back pressure valve arranged in the cathode off-gas exhaust passage, and is connected to an outlet of the cathode passage; a circulation passage that connects a part located further downstream than the first pump in the cathode gas supply passage to a part located further upstream than the back pressure valve in the cathode off-gas exhaust passage, includes a second pump that discharges cathode off-gas and is arranged in the circulation passage, and circulates the cathode off-gas from the cathode off-gas exhaust passage to the cathode gas supply passage; and a control unit that executes, when idling operation is requested, cathode circulation control that operates the second pump to circulate the cathode off-gas, and executes, after the idling operation is shifted to load operation, depressurization control that increases an opening degree of the back pressure valve to greater than an opening degree during the idling operation to decrease a cathode back pressure to less than a cathode back pressure during the idling operation for a period taken for an oxygen concentration in the fuel cell stack to reach a predetermined value. This configuration enables to promptly replace gas in the fuel cell stack after the circulation control of cathode gas.

The control unit may close the back pressure valve and execute the cathode circulation control during the idling operation. Moreover, the control unit may cause the first pump to discharge cathode gas to increase the cathode back pressure during the idling operation. Furthermore, the control unit may execute depressurization control that fully opens the back pressure valve to decrease the cathode back pressure close to atmospheric pressure during shift from the idling operation to the load operation. This configuration enables to replace gas in the fuel cell stack more efficiently.

Moreover, the fuel cell system may further include an open valve arranged in parallel to the back pressure valve, and the control unit may open the open valve during the shift from the idling operation to the load operation. This configuration enables to further increase the efficiency of the gas replacement.

### Effects of the Invention

The fuel cell system disclosed in the present description promptly replaces gas in a fuel cell stack after the circulation control of cathode gas.

### BRIEF DESCRIPTION OF THE DRAWINGS

FIG. 1 is an explanatory diagram illustrating an overview configuration of a fuel cell system of a first embodiment;

FIG. 2 is a flowchart illustrating control of the fuel cell system in the first embodiment;

FIG. 3 is an example of a time chart indicating the instruction of the fuel cell system and the operation of each component in the first embodiment;

FIG. 4 is an example of a time chart indicating the instruction of the fuel cell system and the operation of each component in a comparative example;

FIG. 5 is a flowchart illustrating control of a fuel system in a second embodiment;

FIG. 6 is an example of a time chart indicating the instruction of the fuel cell system and the operation of each component in the second embodiment;

FIG. 7 is a graph illustrating a gas replacement ratio in a stack after the cathode circulation operation is stopped; and

FIG. 8 is an explanatory diagram illustrating an overview configuration of a fuel cell system of a third embodiment.

### MODES FOR CARRYING OUT THE INVENTION

Hereinafter, a description will be given of embodiments of the present invention with reference to accompanying drawings. In the drawings, the dimension of, and the ratio of each portion may be not illustrated so as to completely correspond to the actual one. The illustration of the specifics may be omitted in some drawings.

### First Embodiment

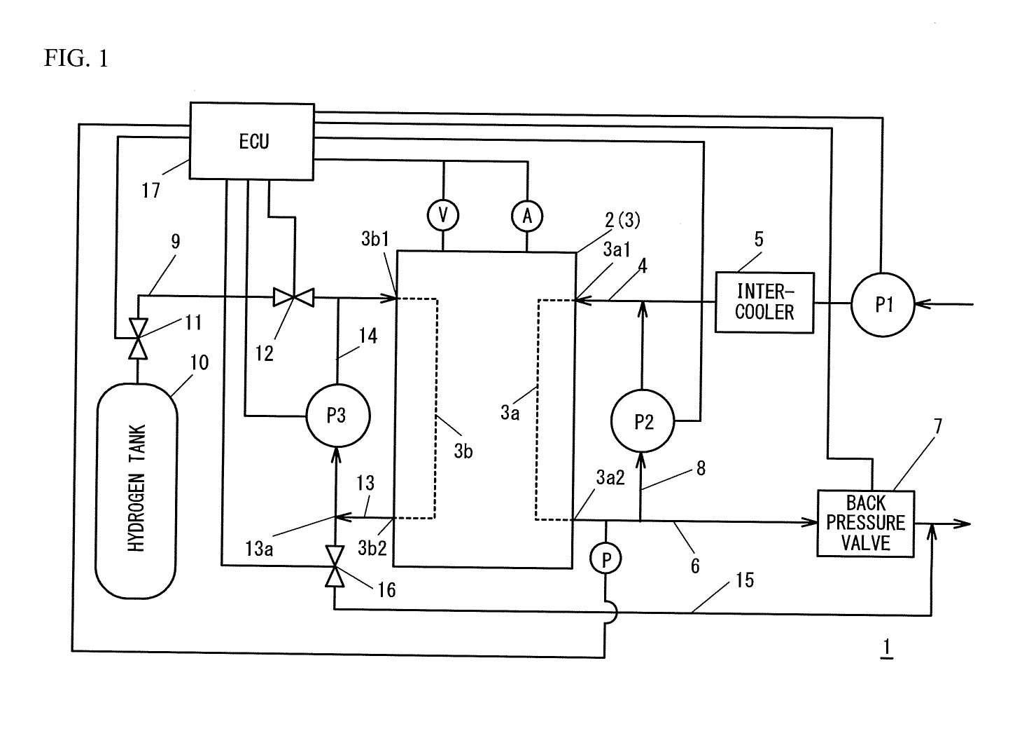

With reference to FIG. 1, a description will first be given of a fuel cell system 1 of a first embodiment. FIG. 1 is an explanatory diagram illustrating an overview configuration of the fuel cell system 1 of the first embodiment. The fuel cell system 1 can be mounted on movable bodies such as vehicles, vessels, planes, and robots, and is also applicable to a stationary power source. Here, a description will be given of the fuel cell system 1 mounted on a vehicle. The fuel cell system 1 includes a fuel cell 2 of solid polyelectrolyte type. The fuel cell 2 includes a fuel cell stack 3 that is formed by stacking unit cells each having a cathode electrode, an anode electrode, and an electrolyte membrane arranged between the cathode electrode and the anode electrode, and includes a cathode passage 3a and an anode passage 3b formed inside the fuel cell stack 3. The electrolyte membrane is, for example, a solid high polymer electrolyte membrane formed of a solid polymer ion exchange membrane. In FIG. 1, the unit cells are not illustrated. A coolant passage, which is not illustrated, is located in the fuel cell stack 3. For the fuel cell stack 3, hydrogen gas, i.e., anode gas is supplied to the anode electrode, and air containing oxygen, i.e., cathode gas is supplied to the cathode electrode. Hydrogen ions generated by catalytic reaction in the anode electrode penetrate through the electrolyte membrane, move to the cathode electrode, and undergoes electrochemical reaction with oxygen to generate electric power. To the fuel cell stack 3, connected are a voltmeter V that measures a voltage value of the generated electricity and an ammeter A that measures a current value of the generated electricity.

A cathode gas supply passage 4 is connected to an inlet 3a1 of the cathode passage 3a of the fuel cell stack 3. A first pump P1 that discharges cathode gas is arranged in the cathode gas supply passage 4. The first pump P1 is a roots pump, and is capable of shutting off the flow of air in a driving stopping state. In the cathode gas supply passage 4, an intercooler 5 is also arranged between the inlet 3a1 of the cathode passage 3a and the first pump P1. The intercooler 5 exchanges heat with a coolant that circulates in the fuel cell stack 3.

A cathode off-gas exhaust passage 6 is connected to an outlet 3a2 of the cathode passage 3a of the fuel cell stack 3. A pressure gauge P is disposed in the cathode off-gas exhaust passage 6. The pressure gauge P measures cathode back pressure described later. In the cathode off-gas exhaust passage 6, a back pressure valve 7 is arranged further downstream than the pressure gauge P. The back pressure valve 7 controls the pressure of the area further upstream than the back pressure valve 7 in the cathode off-gas exhaust passage 6, i.e., cathode back pressure. The cathode back pressure can be obtained from the pressure gauge P.

The fuel cell system 1 includes a circulation passage 8 that connects the cathode gas supply passage 4 to the cathode off-gas exhaust passage 6. More specifically, the circulation passage 8 connects a part located further downstream than the first pump P1 in the cathode gas supply passage 4 to a part located further upstream than the back pressure valve 7 in the cathode off-gas exhaust passage 6. A second pump P2 that discharges cathode off-gas is arranged in the circulation passage 8. This configuration allows the circulation passage 8 to circulate cathode off-gas from the cathode off-gas exhaust passage 6 to the cathode gas supply passage 4. Accordingly, cathode off-gas is supplied again to the cathode passage 3a through the cathode gas supply passage 4. As described in detail later, when idling operation is requested, cathode circulation control that operates the second pump P2 to circulate cathode off-gas is executed.

An anode supply passage 9 is connected to an inlet 3b1 of the anode passage 3b of the fuel cell stack 3. A hydrogen tank 10 that is a supply source of hydrogen is connected to the end of the anode supply passage 9. The hydrogen tank 10 stores high-pressure hydrogen. A shut valve 11 that shuts off the supply of hydrogen and a regulator 12 that reduces the pressure of hydrogen are arranged in the anode supply passage 9.

An exhaust pipe 13 is connected to an outlet 3b2 of the anode passage 3b of the fuel cell stack 3. The exhaust pipe 13 diverges into a circulation passage 14 and a purge passage 15 at a diverging point 13a. A third pump P3 is arranged in the circulation passage 14. The arrangement of the third pump P3 in the circulation passage 14 allows anode off-gas to be supplied again to the anode passage 3b. The purge passage 15 that diverges at the diverging point 13a is connected to the downstream side of the back pressure valve 7 disposed in the cathode off-gas exhaust passage 6. A purge valve 16 is arranged in the purge passage 15. When the purge valve 16 is opened, anode off-gas that is not to be circulated is discharged together with cathode off-gas.

The fuel cell system 1 includes an ECU (Electronic Control Unit) 17. The ECU 17 is configured as a microcomputer including a CPU, a ROM, and a RAM thereinside, and functions as a control unit. That is to say, the ECU 17 executes the cathode circulation control that operates the second pump P2 to circulate cathode off-gas when the fuel cell system 1 is requested to execute idling operation. At this time, the ECU 17 closes the back pressure valve 7. In addition, the ECU 17 executes depressurization control that increases the opening degree of the back pressure valve 7 to reduce the cathode back pressure for a period taken for the oxygen concentration in the fuel cell stack 3 to reach a predetermined value after idling operation has been shifted to load operation. The pressure gauge P, the voltmeter V, and the ammeter A are electrically connected to the ECU 17. The first pump P1, the second pump P2, and the third pump P3 are coupled to the ECU 17, and the ECU 17 controls the driving of these pumps. Furthermore, the back pressure valve 7, the shut valve 11, the regulator 12, and the purge valve 16 are electrically connected to the ECU 17, and the ECU 17 controls the opening and the closing of these valves. The values detected by other sensors are input to the ECU 17. The ECU 17 also stores a current-voltage map and any other map. The ECU 17 described above executes an output setting process. That is to say, the ECU 17 sets the voltage value and the current value output from the fuel cell 2 based on the output request to the fuel cell system 1 from the vehicle described later, the current-voltage map, and the output history, and sets the air supply amount, the cathode back pressure, the hydrogen supply amount, and hydrogen pressure based on the voltage value and the current value. Furthermore, to the ECU 17, input are detected information of an accelerator opening sensor, a break sensor, a parking break sensor, a shift selector, a navigation system, a horizontal G sensor, and a vehicle speed sensor that are not illustrated. The ECU 17 calculates the output request to the fuel cell system 1 from the vehicle in accordance with the detected information, and determines whether the fuel cell system 1 is requested to execute idling operation, or whether the shift from idling operation to load operation is requested. Here, the idling operation of the fuel cell system 1 indicates the state where the fuel cell system 1 is requested to generate electric power in a low load region, or the state where the fuel cell system 1 is on standby for power generation. The ECU 17 executes idling operation when the output request to the fuel cell system 1 is less than a predetermined value that is preliminarily determined. The load operation indicates the state where the output request to the fuel cell system 1 is equal to or greater than the above-described predetermined value that is preliminarily determined, and indicates a state that does not correspond to idling operation.

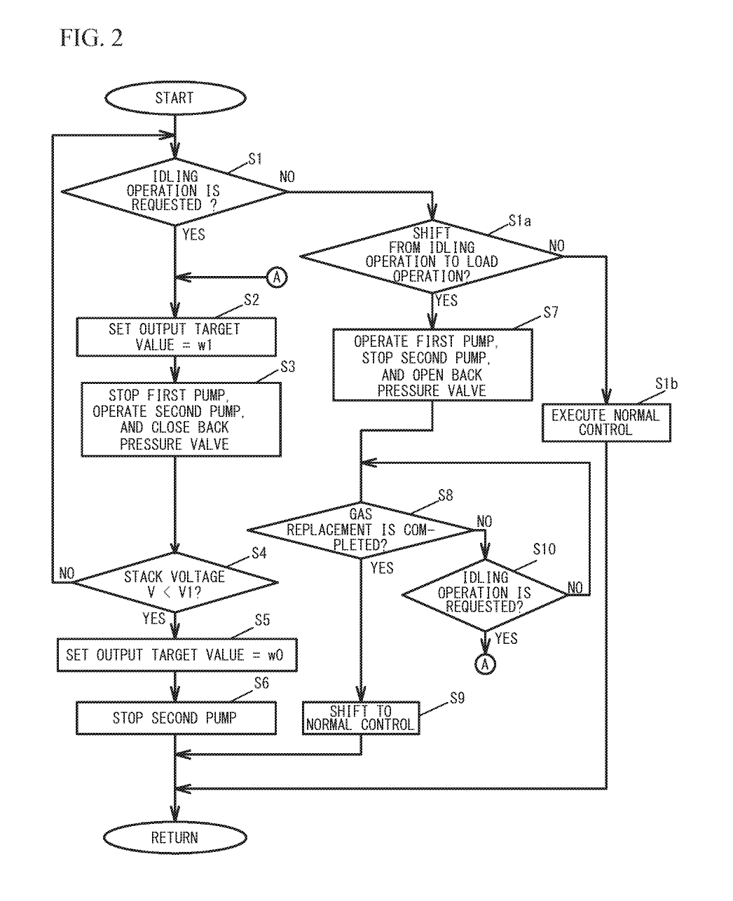

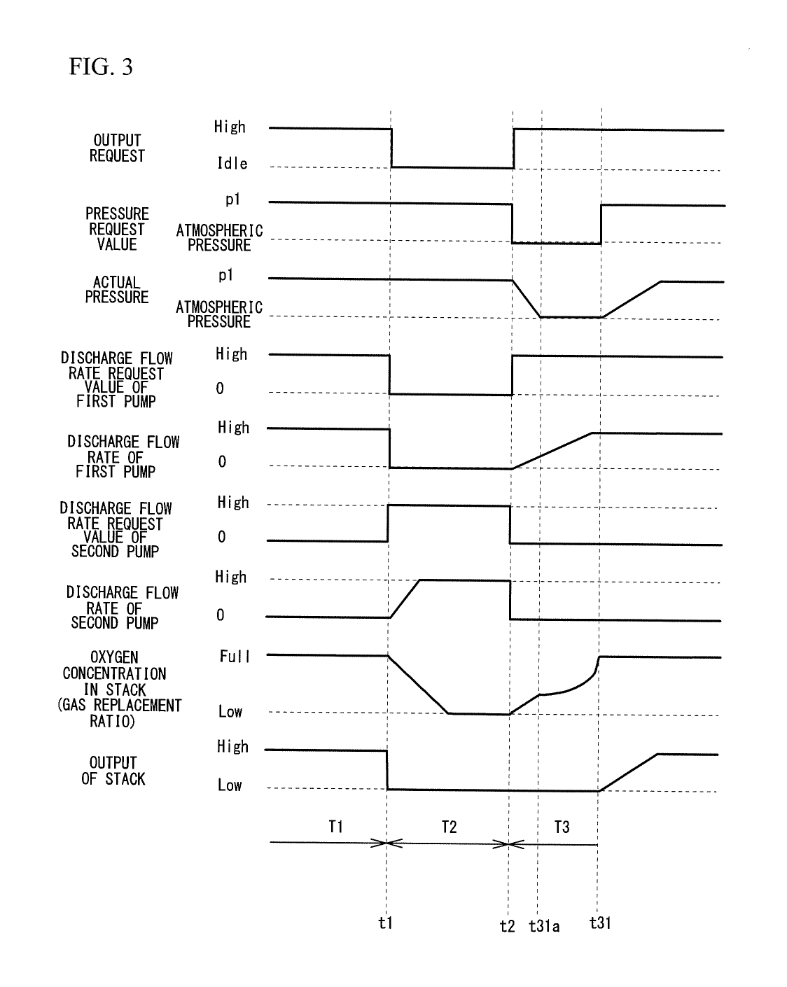

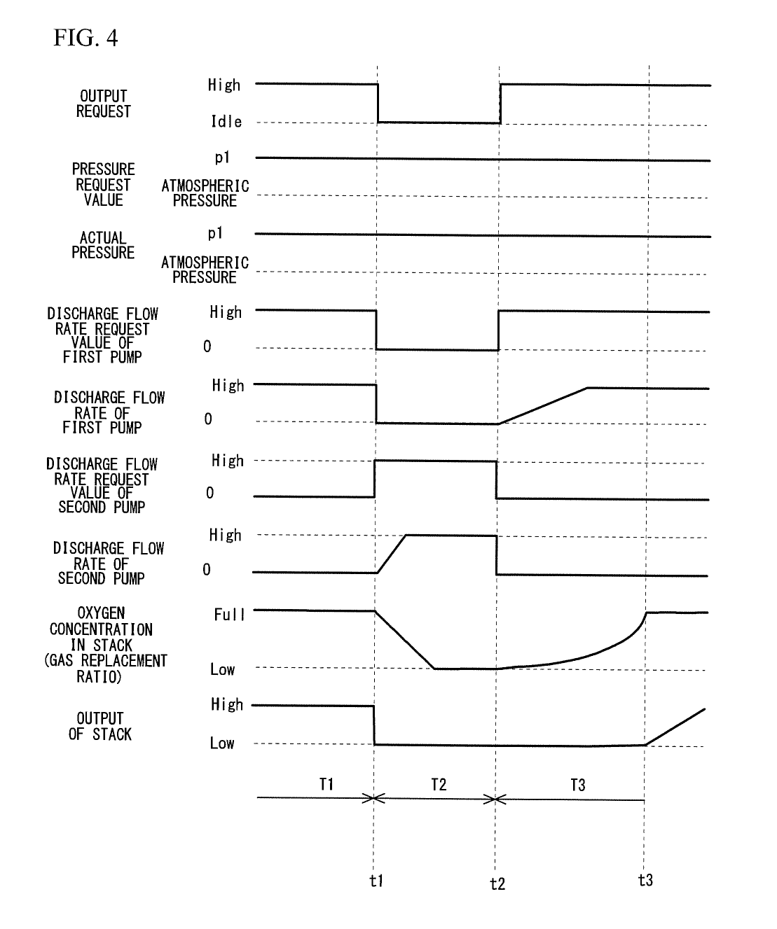

With reference to FIG. 2, FIG. 3, and FIG. 4, a description will next be given of the control of the fuel cell system 1 of the first embodiment. FIG. 2 is a flowchart illustrating the control of the fuel cell system 1 in the first embodiment. FIG. 3 is an example of a time chart indicating the instruction value of the fuel cell system 1 and the operation of each component in the first embodiment. FIG. 4 is an example of a time chart indicating the instruction of a fuel cell system and the operation of each component in a comparative example. The fuel cell system of the comparative example has a hardware configuration common to that of the fuel cell system 1 of the first embodiment, but differs from the fuel cell system 1 of the first embodiment in the specifics of the control. In the following description, a description will first be given of the control of the fuel cell system 1 of the first embodiment. The difference in the control and the difference in effect between the first embodiment and the comparative example will be described in detail later.

Assume the state where the fuel cell system 1 executes load operation. The period indicated by referential mark T1 in FIG. 3 represents the period during which the fuel cell system 1 executes load operation. While the fuel cell system 1 executes load operation, the output request is High. Setting the output request to High in FIG. 3 represents that the output request equal to or greater than the predetermined value is made to the fuel cell system 1. When the output request is High, the pressure request value that the ECU 17 sets as the cathode back pressure is pressure p1 greater than atmospheric pressure. In accordance with the setting of the pressure request value p1 by the ECU 17, the actual pressure (cathode back pressure) measured by the pressure gauge P is p1. The ECU 17 sets the discharge flow rate request value of the first pump P1 to High. Accordingly, the actual discharge flow rate of the first pump P1 is High. The ECU 17 sets the discharge flow rate request value of the second pump P2 to zero. Accordingly, the actual discharge flow rate of the second pump P2 is zero. That is to say, the cathode circulation control is not executed. Here, the state where the discharge flow rate request value of the first pump P1 is High means the state where the first pump P1 is in an ON (operating) state, and the state where the discharge flow rate request value of the first pump P1 is zero means the state where the first pump P1 is in an OFF (stopping) state. In such a load operation state, the oxygen concentration in the stack is in a state of Full. The state where the oxygen concentration in the stack is in a state of Full means the state where the oxygen concentration at the inlet 3a1 of the cathode passage 3a located in the fuel cell stack 3 is approximately equal to the oxygen concentration in outside air, and the state ready for load operation that allows the fuel cell system 1 to obtain desired output. When the oxygen concentration in the stack becomes high, the output of the stack is in a state capable of achieving high output (High). Although it is not illustrated in FIG. 3, the discharge flow rate of the third pump P3 is also in a state of High during load operation, i.e., anode gas is circulated.

As described above, the ECU 17 determines whether the fuel cell system 1 is requested to execute idling operation based on the detected information of the accelerator opening sensor, the break sensor, the parking break sensor, and any other sensor. When the ECU 17 determines that idling operation is requested at time t1, the ECU 17 makes a determination of YES at step S1, and sets the output request to Idle. Then, the ECU 17 shifts to the cathode circulation control executed during period T2 in FIG. 3. More specifically, the ECU 17 proceeds to step S2, and sets the output target value to w1. Here, w1 of the output target value is set as an output value that can cover the electric power required for the operation of the fuel cell system 1 thereafter. For example, w1 is set to the output value that can cover the electric power required for driving the second pump P2.

At step S3 subsequent to step S2, the ECU 17 starts the cathode circulation control. That is to say, the ECU 17 stops the first pump P1, and starts the operation of the second pump P2. Furthermore, the ECU 17 closes the back pressure valve 7. More specifically, as illustrated in FIG. 3, the discharge flow rate request value of the first pump P1 is set to zero. Accordingly, the discharge flow rate of the first pump P1 becomes zero. The discharge flow rate request value of the second pump P2 is set to high. The setting of the discharge flow rate request value causes the actual discharge flow rate of the second pump P2 to become High. The actual discharge flow rate of the second pump P2 rises from a discharge flow rate of 0, gradually increases, and reaches the final discharge flow rate. Here, the discharge flow rate requirement value of the second pump P2 is not required to be a strict value, and may be a value as long as cathode off-gas is allowed to flow by the drive of the second pump P2. As described above, when the operation of the first pump P1 is stopped and the operation of the second pump P2 is started, fresh air is not introduced into the fuel cell system 1, and cathode off-gas circulates. That is to say, fresh air introduced into the cathode passage 3a decreases. This results in a gradual decrease in the oxygen concentration in the stack from a state of Full. As described above, when the oxygen concentration in the fuel cell stack 3 decreases, the output of the stack becomes less than the output at time t1 at which idling operation is started. In the idling request state from time t1, the pressure request value is maintained at pressure p1 as with the pressure before time t1. Here, the reason why the actual pressure is maintained at p1 even when the operation of the first pump P1 is stopped is because the back pressure valve 7 is closed. In the first embodiment, step S3 is executed subsequent to step S2, but step S2 and step S3 may be simultaneously executed, or the order of steps S2 and S3 may be changed. At step S3 in the present embodiment, the back pressure valve 7 is fully closed, but may not have to be fully closed. This is because when cathode off-gas is circulated by the second pump P2 that is a circulation pump, the oxygen concentration in the fuel cell stack 3 decreases, and the output voltage is decreased. However, the internal pressure of the fuel cell stack 3 is increased by fully closing the back pressure valve 7 even when the first pump P1 is not operated. Thus, the back pressure valve 7 is preferably fully closed. Here, the state where the back pressure valve 7 is fully closed includes not only the state where cathode off-gas does not flow downstream of the back pressure valve 7 at all but also the state where the opening degree of the back pressure valve 7 is close to zero and cathode off-gas slightly flows downstream of the back pressure valve 7. The reason why the internal pressure of the fuel cell stack 3 is increased is to release the cathode back pressure at a stroke to execute a purge, and promotes the gas replacement.

The ECU 17 determines whether the stack voltage measured by the voltmeter V is less than a predetermined voltage V1 at step S4 subsequent to step S3. Here, the predetermined voltage V1 is set as a voltage that prevents the cathode electrode from having high electric potential when the fuel cell system 1 becomes in an idling state, and inhibits the deterioration of the fuel cell 2. In the fuel cell system 1 during idling operation, the voltage gradually decreases to less than the voltage V1 by the execution of the cathode circulation control. When the ECU 17 makes a determination of YES at step S4, the ECU 17 moves to step S5. At step S5, the ECU 17 sets the output target value of the fuel cell system 1 to w0. At step S6 subsequent to step S5, the ECU 17 stops the second pump P2. The reason why the ECU 17 sets the output target value of the fuel cell system 1 to w0 to decrease the output target value at step S5 is because the operation of the second pump P2 becomes unnecessary and the electric power consumption decreases after the stack voltage decreases to less than V1. The process returns after step S6. The order of step S5 and step S6 may be changed, or step S5 and step S6 may be simultaneously executed. The processes from step S2 to step S6 correspond to the cathode circulation control. On the other hand, when the determination at step S4 is NO, the process is repeated from step S1. As described above, the process is repeated from step S1, and the control that sets the output target value to w1 is continued till the determination at step S4 becomes YES.

On the other hand, when the determination at step S1 is NO, the process moves to step S1a. At step S1a, the ECU 17 determines whether the shift from idling operation to load operation is being executed. That is to say, the ECU 17 determines whether the fuel cell system 1 is executing the process of step S1a after step S1 that has been executed again because of the return of the series of processes during idling operation. When the ECU 17 makes a determination of NO at step S1a, the ECU 17 moves to step S1b and executes normal control, and the process returns. Here, the normal control indicates the control under which load operation is being executed and the depressurization control described in detail later is not being executed. For example, the normal control is executed in a case where the state within period T1 illustrated in FIG. 3 is continued. On the other hand, when the determination at step S1a is YES, the process moves to step S7. That is to say, when the ECU 17 determines that idling operation is not requested at time t2 in FIG. 3, the ECU 17 makes a determination of NO at step S1, and sets the output request to High. That is to say, the fuel cell system 1 shifts from idling operation to load operation. At this time, the ECU 17 executes the depressurization control that increases the opening degree of the back pressure valve 7 to decrease the pressure in the fuel cell stack 3 to less than the pressure during idling operation. More specifically, at step S7, the ECU 17 starts the operation of the first pump P1, stops the operation of the second pump P2, and increases the opening degree of the back pressure valve 7. This control decreases the cathode back pressure to less than the cathode back pressure during idling operation. The state where the depressurization control is being executed indicates the state where the opening degree of the back pressure valve 7 is greater than the opening degree during idling operation and the cathode back pressure is less than the cathode back pressure during the idling operation. As illustrated in FIG. 3, when the discharge flow rate request value of the first pump P1 is set to High, the discharge flow rate of the first pump P1 becomes High. That is to say, achieved is the state capable of reacting to the output request during load operation. Moreover, the discharge flow rate request value of the second pump P2 is set to zero. This setting of the discharge flow rate request value causes the actual discharge flow rate of the second pump P2 to be zero. The actual discharge flow rate of the first pump P1 rises from a discharge flow rate of 0, gradually increases, and reaches a discharge flow rate of High eventually. As described above, when the operation of the first pump P1 is started and the operation of the second pump P2 is stopped, the oxygen concentration in the stack comes close to Full. At this time, the ECU 17 sets atmospheric pressure as the pressure request value of the cathode back pressure, and fully opens the back pressure valve 7. This control promotes the gas replacement in the cathode passage 3a at a stroke. As a result, fresh air containing rich oxygen is introduced into the cathode passage 3a, and the oxygen concentration in the stack increases. FIG. 3 reveals that the oxygen concentration in the stack returns to a state of Full from time t2 to time t31, the gas replacement linearly proceeds between time t2 and time t31a, and the oxygen concentration in the stack increases. The linear progression of the gas replacement is caused by the execution of a purge achieved by releasing the cathode back pressure, which has been maintained at pressure P1 till time t2, at a stroke. Here, define the gas replacement ratio as a ratio of the oxygen concentration at each time to an attainment target value of the oxygen concentration in the stack when the gas replacement is executed during the shift from idling operation to load operation. The gas replacement ratio after time t31a increases in a quadric curve shape, and reaches a state of Full eventually.

In the present embodiment, the gas replacement is promoted by setting the cathode back pressure to atmospheric pressure during the depressurization control. However, the effect of the gas replacement can be obtained as long as the cathode back pressure during the depressurization control is less than the cathode back pressure during idling state. That is to say, the back pressure valve 7 may not be fully opened and the cathode back pressure may not be equal to atmospheric pressure as long as the cathode back pressure during the depressurization control is less than the cathode back pressure during idling state. The state where the back pressure valve 7 is fully opened includes the state where the opening degree of the back pressure valve 7 is approximately 100%, and the cathode back pressure does not substantially differ from the cathode back pressure when the back pressure valve 7 is fully opened. The state where the cathode back pressure is approximately the same as atmosphere includes a state where the cathode back pressure is slightly greater than atmospheric pressure because of the pressure loss of the back pressure valve 7 itself.

At step S8, the ECU 17 determines whether the gas replacement in the cathode passage 3a is completed. To determine whether the gas replacement is completed, the ECU 17 estimates the supply amount of fresh air from the start of the operation of the first pump P1 at time t2, and makes a determination based on the estimated amount. Alternatively, the oxygen concentration at the outlet 3a2 of the cathode passage 3a is measured, and it may be determined that the gas replacement is completed when the measured value exceeds a threshold value preliminarily determined. Step S7 and step S8 correspond to the depressurization control. When the ECU 17 makes a determination of YES at step S8, i.e., when the ECU 17 confirms that the oxygen concentration in the stack reaches a state of Full, the ECU 17 moves to step S9, and shifts to the normal control. On the other hand, when the ECU 17 makes a determination of NO at step S8, the ECU 17 repeats the process till the determination at step S8 becomes YES. After the ECU 17 makes a determination of YES at step S8, the ECU 17 moves to step S9, shifts to the normal control, and sets the pressure request value to pl. After step S9, the process returns. When the determination at step S8 is NO, the ECU 17 determines again whether idling operation is requested at step S10. This process is for handling a case where idling operation is requested during the depressurization control. When the determination at step S10 is YES, the process moves to step S2. On the other hand, when the determination at step S10 is NO, the process of step S8 is repeated.

As described above, the fuel cell system 1 of the present embodiment executes the depressurization control that increases the opening degree of the back pressure valve 7 to decrease the cathode back pressure when the fuel cell system 1 shifts from idling operation to load operation. Accordingly, the gas in the fuel cell stack is promptly replaced after the circulation control of the cathode gas.

In contrast, in the comparative example of which the time chart is illustrated in FIG. 4, after the shift instruction from idling operation to load operation is issued, period T3 taken for the oxygen concentration in the stack to reach a state of Full is longer than period T3 in the first embodiment. The comparative example differs from the first embodiment in the setting of the pressure request value and the actual pressure according to the setting. Unlike the first embodiment, the pressure request value is constant in the comparative example. That is to say, even when the fuel cell system shifts from idling state to load operation, the pressure request value of the cathode back pressure is maintained constant. As described above, when the pressure request value is maintained constant and the cathode back pressure is actually maintained constant, the oxygen concentration in the stack increases in a quadric curve shape till the oxygen concentration reaches a state of Full after the shift instruction from idling operation to load operation is issued. That is to say, the period taken for the gas replacement to be completed is long. As described above, the increase in the period taken for the gas replacement to be completed causes a problem such as a control delay that requires time to obtain the requested output. Compared to the comparative example, the fuel cell system 1 of the first embodiment promptly completes the gas replacement, and obtains the desired output immediately.

The fuel cell system 1 of the first embodiment includes the intercooler 5 arranged in the cathode gas supply passage 4. The intercooler 5 has a chamber through which the large amount of air flows. Thus, when the back pressure valve 7 is opened, air in the chamber extrudes the gas in the cathode passage 3a, and increases the efficiency of scavenging during the gas replacement. In the present embodiment, the pressure gauge P is disposed in the cathode off-gas exhaust passage 6 located further downstream than the fuel cell stack 3, but this arrangement does not intend to suggest any limitation. The pressure gauge P may be arranged in the cathode gas supply passage 4 further upstream than the fuel cell stack 3, for example. This is because the cathode back pressure can be calculated by subtracting the pressure loss in the fuel cell stack 3 stored in advance in accordance with the conditions such as the cathode gas flow rate and the stack temperature even when the pressure gauge P is arranged at the cathode gas supply passage 4 side.

### Second Embodiment

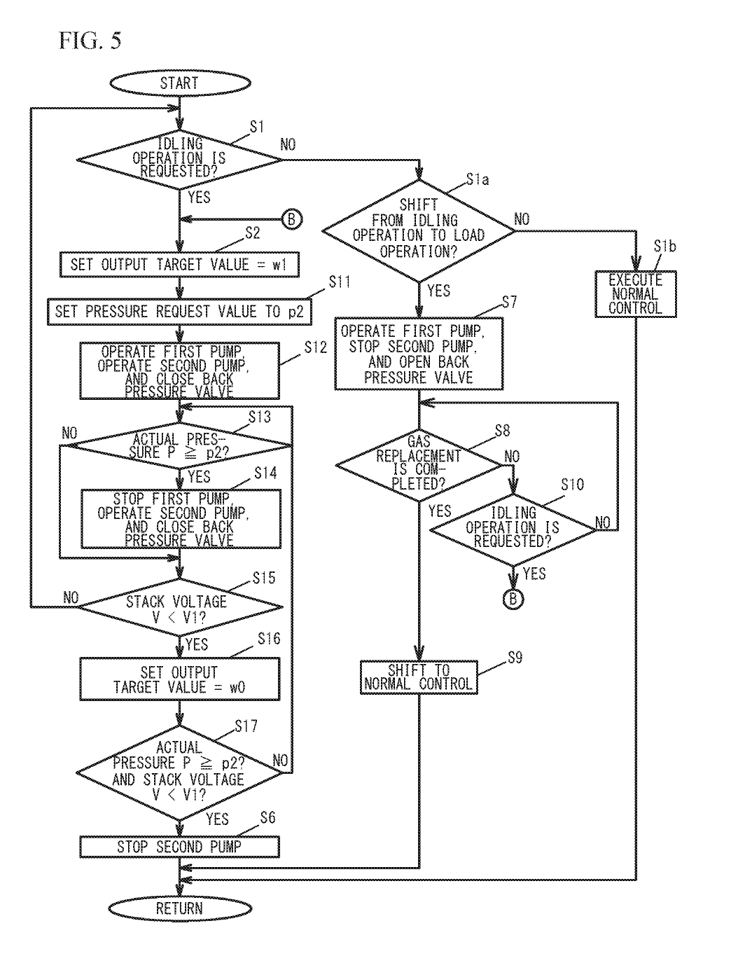

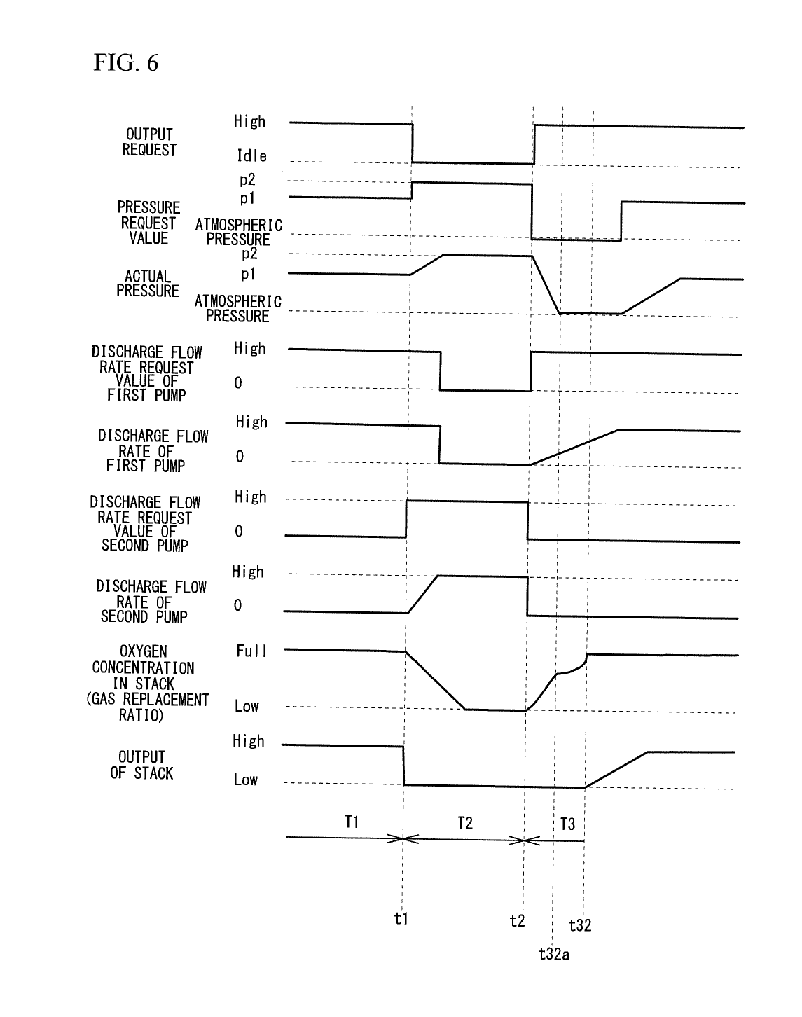

A description will next be given of a second embodiment with reference to FIG. 5 and FIG. 6. FIG. 5 is a flowchart illustrating the control of the fuel cell system 1 in the second embodiment. FIG. 6 is an example of a time chart indicating the instruction of the fuel cell system 1 and the operation of each component in the second embodiment. The second embodiment differs from the first embodiment in the control, but has a hardware configuration of the fuel cell system 1 common to that of the first embodiment. Therefore, in the following description, the difference in the control between the second embodiment and the first embodiment is mainly described.

At step S1, as with the first embodiment, the ECU 17 determines whether idling operation of the fuel cell system 1 is requested. When the determination at step S1 is YES, the process moves to step S2. When the determination at step S1 is NO, the process moves to step S1a. At step S1a, as with the first embodiment, the ECU 17 determines whether it is a return from idling operation. When the determination at step S1a is YES, the process moves to step S7. When the process moves to step S7, the processes from step S7 to step S9 are common to those of the first embodiment. At step S2, as with the first embodiment, the ECU 17 sets the output target value to w1. After step S2, the process moves to step S11. When the determination at step S1a is NO, as with the first embodiment, the process returns after the process of step S1b.

At step S11, the ECU 17 sets the pressure request value to p2. The pressure request value is a back pressure control value in other words. Pressure value p2 is greater than pressure value p1. That is to say, at step S11, the ECU 17 sets the pressure request value to a value greater than the preceding pressure request value used in the normal control. At step S12 subsequent to step S11, the ECU 17 operates the first pump P1 and the second pump P2, and closes the back pressure valve 7. That is to say, to increase the pressure value from p1 to p2, the operation of the first pump P1 is continued. As described above, the second embodiment differs from the first embodiment in that the operation of the first pump P1 is continued to increase the pressure value. In the present embodiment, the back pressure valve 7 is fully closed, but may not have to be fully closed. The state where the back pressure valve 7 is fully closed includes not only the state where cathode off-gas does not flow downstream of the back pressure valve 7 at all but also the state where the opening degree of the back pressure valve 7 is close to 0 and cathode off-gas slightly flows downstream of the back pressure valve 7. These definitions are the same as those of the first embodiment.

At step S13 subsequent to step S12, the ECU 17 determines whether the actual pressure p, i.e., the cathode back pressure p measured by the pressure gauge P is equal to p2 or greater. When the determination at step S13 is YES, the process moves to step S14. At step S14, the ECU 17 stops the operation of the first pump P1. Then, the ECU 17 continues the operation of the second pump P2, and maintains the closed state of the back pressure valve 7. This control is common to the control at step S3 of the first embodiment. After step S14, the process moves to step S15. On the other hand, when the determination at step S13 is NO, the process skips step S14, and moves to step S15.

At step S15, the ECU 17 determines whether the stack voltage V measured by the voltmeter V is less than the predetermined voltage V1. This process is common to the process at step S4 in the first embodiment. When the determination at step S15 is YES, the process moves to step S16. At step S16, the ECU 17 sets the output target value of the fuel cell system 1 to w0. This process is common to the process at step S5 of the first embodiment. After step S16, the process moves to step S17. When the determination at step S15 is NO, the process is repeated from step S1. This is common to the case where the determination at step S4 is NO in the first embodiment.

At step S17, the ECU 17 determines whether the actual pressure p is equal to p2 or greater, and the stack voltage V is less than V1. When the determination at step S17 is YES, the process returns after step S6 common to the first embodiment. On the other hand, when the determination at step S17 is NO, the process is repeated from step S13 till the determination at step S17 becomes YES.

When the determination at step S1 is NO and the process moves to step S7, the processes from step S7 to step S9 are common to those of the first embodiment as described above. However, the effect differs from the effect of the first embodiment. More specifically, period T3 taken for the oxygen concentration in the stack to reach a state of Full after the shift instruction from idling operation to load operation is issued is further shorter than period T3 of the first embodiment. The reason will be described. In the second embodiment, the cathode back pressure is increased to p2 during idling operation. That is to say, the difference from atmospheric pressure increases. Accordingly, when the back pressure valve 7 is released when the fuel cell system 1 returns from idling operation, the remaining gas in the cathode passage 3a is exhausted vigorously, and the gas replacement is executed efficiently. This results in the shortening of the interval between time t2 and time t32a as illustrated in FIG. 6, and the line indicating the gas replacement ratio is close to the vertical. This also reduces period T3 to time t32 at which the oxygen concentration in the stack reaches a state of Full.

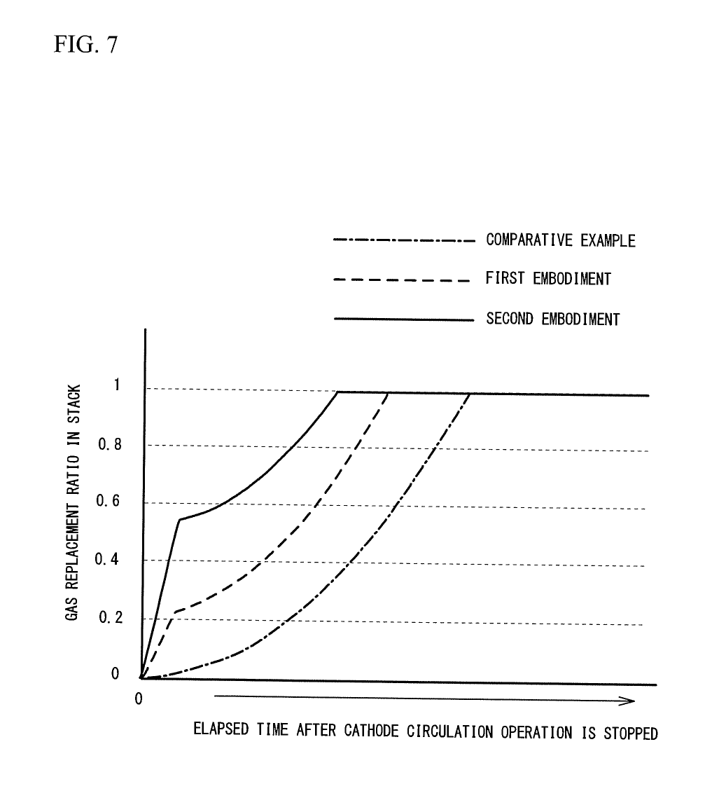

As described above, the gas is replaced more efficiently by increasing the cathode back pressure during idling operation period T2. The reason why the above difference is made is considered as follows with reference to FIG. 7. When the cathode back pressure is not reduced during the shift from idling operation to load operation as with that of the comparative example described in the first embodiment, the change in the gas replacement ratio in the stack is represented by a quadratic curve all the time. As a result, it takes long time for the replacement of all of the gas to be completed. In contrast, as described in the first embodiment, when the depressurization control that decreases the cathode back pressure to less than the preceding cathode back pressure is executed at the time of shift from idling operation to load operation, the purge due to the decrease of the cathode back pressure promotes the gas replacement at a stroke. This reduces the time taken for the replacement of all of the gas to be completed. In the second embodiment, the cathode back pressure is increased during idling operation to increase the difference between the cathode back pressure and the pressure after the back pressure valve 7 is released. This configuration enables to execute further efficient gas replacement. Accordingly, time taken for the replacement of all of the gas to be completed is further shortened.

### Third Embodiment

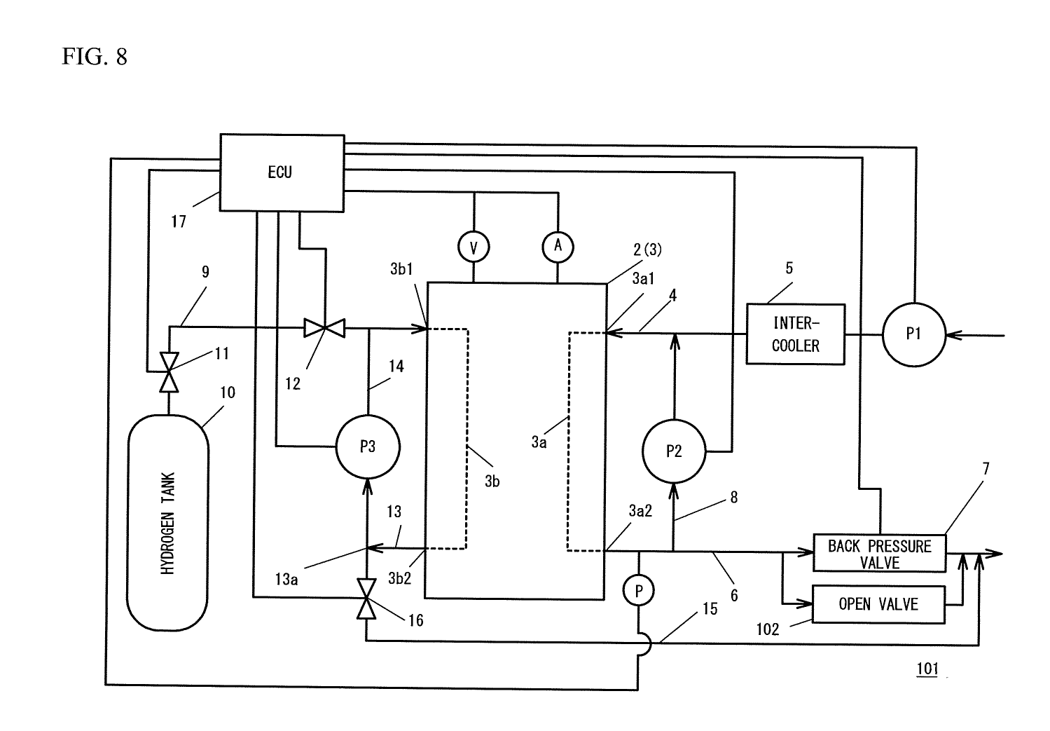

A description will next be given of a third embodiment with reference to FIG. 8. A fuel cell system 101 of the third embodiment differs from the fuel cell system 1 of the first embodiment in that an open valve 102 arranged in parallel to the back pressure valve 7 is provided. Other components are the same as those of the fuel cell system 1 of the first embodiment. Thus, the same reference numerals are affixed to the common components in the drawing, and the detailed description will be omitted.

The open valve 102 assists the exhaust of cathode off-gas from the back pressure valve 7. The open valve 102 is opened in combination with the back pressure valve 7 when the cathode circulation control during idling operation is shifted to the depressurization control. This configuration increases the efficiency of the decrease in the cathode back pressure, thereby increasing the efficiency of the gas replacement. The increase in the efficiency of the gas replacement allows oxygen to spread across the wide area of the fuel cell stack 3 immediately, and allows the fuel cell system 101 to become a state where the fuel cell system 101 can output a high electric potential in a short period of time.

While the exemplary embodiments of the present invention have been illustrated in detail, the present invention is not limited to the above-mentioned embodiments, and other embodiments, variations and variations may be made without departing from the scope of the present invention.

### DESCRIPTION OF LETTERS OR NUMERALS

1, 101 fuel cell system

2 fuel cell

3 fuel cell stack

3a cathode passage

4 cathode gas supply passage

5 intercooler

6 cathode off-gas exhaust passage

7 back pressure valve

8 circulation passage

102 open valve

P1 first pump

P2 second pump

P3 third pump

1. A fuel cell system comprising:
a fuel cell stack that is formed by stacking unit cells each including a cathode electrode, an anode electrode, and an electrolyte membrane arranged between the cathode electrode and the anode electrode, and includes a cathode passage and an anode passage formed inside the fuel cell stack;
a cathode gas supply passage that includes a first pump that discharges cathode gas and is arranged in the cathode gas supply passage, and is connected to an inlet of the cathode passage;
a cathode off-gas exhaust passage that includes a back pressure valve arranged in the cathode off-gas exhaust passage, and is connected to an outlet of the cathode passage;
a circulation passage that connects a part located further downstream than the first pump in the cathode gas supply passage to a part located further upstream than the back pressure valve in the cathode off-gas exhaust passage, includes a second pump that discharges cathode off-gas and is arranged in the circulation passage, and circulates the cathode off-gas from the cathode off-gas exhaust passage to the cathode gas supply passage; and
a control unit that executes, when idling operation is requested, cathode circulation control that operates the second pump to circulate the cathode off-gas so that a cathode back pressure increases to greater than a cathode back pressure during normal control, and executes, after the idling operation is shifted to load operation, depressurization control that increases an opening degree of the back pressure valve to greater than an opening degree during the idling operation to decrease the cathode back pressure to less than the cathode back pressure during the idling operation for a period taken for an oxygen concentration in the fuel cell stack to reach a predetermined value.

2. The fuel cell system according to claim 1, wherein
the control unit closes the back pressure valve and executes the cathode circulation control during the idling operation.

3. The fuel cell system according to claim 2, wherein
the control unit causes the first pump to discharge cathode gas to increase the cathode back pressure during the idling operation.

4. The fuel cell system according to claim 1, wherein
the control unit executes depressurization control that fully opens the back pressure valve to decrease the cathode back pressure close to atmospheric pressure during shift from the idling operation to the load operation.

5. The fuel cell system according to claim 4, further comprising:
an open valve arranged in parallel to the back pressure valve,
wherein the control unit opens the open valve during the shift from the idling operation to the load operation.

6. A fuel cell system comprising:
a fuel cell stack that is formed by stacking unit cells each including a cathode electrode, an anode electrode, and an electrolyte membrane arranged between the cathode electrode and the anode electrode, and includes a cathode passage and an anode passage formed inside the fuel cell stack;
a cathode gas supply passage that includes a first pump that discharges cathode gas and is arranged in the cathode gas supply passage, and is connected to an inlet of the cathode passage;
a cathode off-gas exhaust passage that includes a back pressure valve arranged in the cathode off-gas exhaust passage, and is connected to an outlet of the cathode passage;
a circulation passage that connects a part located further downstream than the first pump in the cathode gas supply passage to a part located further upstream than the back pressure valve in the cathode off-gas exhaust passage, includes a second pump that discharges cathode off-gas and is arranged in the circulation passage, and circulates the cathode off-gas from the cathode off-gas exhaust passage to the cathode gas supply passage;
an open valve arranged in parallel to the back pressure valve; and
a control unit that executes, when idling operation is requested, cathode circulation control that operates the second pump to circulate the cathode off-gas, executes, after the idling operation is shifted to load operation, depressurization control that fully opens the back pressure valve and opens the open valve to decrease the cathode back pressure close to atmospheric pressure for a period taken for an oxygen concentration in the fuel cell stack to reach a predetermined value.
